(19) United States
(12) Patent Application Publication
(10) Pub. No.: US 2008/0189259 A1
(43) Pub. Date: Aug. 7, 2008

(54) Method For Preserving Access To Deleted And Overwritten Documents By Means Of A System Recycle Bin

(76) Inventor: Rajesh Kapur, Scarborough (CA)

Correspondence Address: Rajesh Kapur, 264 Huntsmill Boulevard, Ontario, Scarborough, M1W 3G6, omitted

(21) Appl. No.: 11/666,635

(22) PCT Filed: Oct. 14, 2005
(86) PCT No.: PCT/CA05/01566

§ 371 Date: Apr. 30, 2007

(30) Foreign Application Priority Data
Apr. 14, 2005 (CA) 2504070
May 16, 2005 (CA) 2506756

(51) Int. Cl. G06F 7/06; G06F 17/30

(52) U.S. Cl. 707/5; 707/103 R; 707/E17.017

(57) ABSTRACT

A method for preserving access to deleted or overwritten document data within a system, wherein said document data is stored in a system filestore associated with a system database containing reference data to point to the document data within the system filestore, the method comprising the steps of: determining that a delete/overwrite command has been issued; recording the reference data prior to the deleting or updating of the reference data; inserting the recorded reference data in a set of access-preservation tables; inserting all other information connected with the before delete reference data contained within system tables into second set of access preservation tables; providing a set of combination tables to point to the deleted/overwritten document data within the filestore; identifying and storing document data deleted to a separate empty filestore; and re-inserting, updating all information preserved for the required document back into system database tables and filestore.

### BACKGROUND OF THE INVENTION

Many large companies use document management software. The purpose of such software is to help companies keep track of large volumes of documents in an organized way, so that documents can be easily stored, found and retrieved. In many cases, there will be more than one version of a particular document. Thus, version control is another aspect of most document management systems. Version control is an issue of particular importance in situations where different people are able to share documents and have shared access to the documents, including a shared right to independently modify the documents.

One example of a company in which a document management software system would be useful is an engineering company that has many versions of the same part. When a client orders that part the company has to find the correct part version of the document or drawing so that the order can be processed.

The document management system typically includes a system database that is associated with a filestore. The filestore stores the actual document data, while the system database stores reference information that points to the document within the filestore. Also, the system database typically stores supplementary document information regarding each document. In many cases the document has different attributes attached to it thereby making it a different type, for example a document, could be a document of type letter, which has the additional attributes or information To:, From:, attached to it, or in the case described above the document could be of type engineering having Part no: and Description: as attributes.

Documentum™ is a document management system that comprises of three different layers (or technologies) sitting on top of an operating system (server based) such as Unix or Windows 2000 server, a system database, and a filestore.

The layers comprise of a Documentum application server layer that sits on top of the database and serves Documentum client interfaces. The reference information (i.e. the information pointing to the physical document data) and supplementary document information (i.e. the attributes of the types of Documents stored) are stored in the database. The actual physical data is stored in a filestore on either the server, a Storage area network (SAN) or Filer pointed to by the server.

As part of the management of documents, documents get deleted from the system database and filestore, or a particular version of the document gets overwritten by a new document as the same version. However, in some cases, the deleting or overwriting gets done in error, with valuable information within the document, or the previous version thereof, being lost in the process. When this happens, it is desirable for the user to be able to get his original document back. However, often, by the time the user realises that he needs his original document back, the document management system has run a standard clean-up routine that makes it effectively impossible to retrieve the deleted or overwritten file. Clean up routines are required because if the system database is not cleaned up every so often inconsistencies can arise in the system database information, which can eventually lead to corruption of the system.

In a previous submission for Patent CTC002, just the minimum amount of information is captured in order to allow systems professionals to retrieve a copy of the file from system backup tapes to the user. In this method, however, all type information, and other data recorded against the document is lost, including the type classification of the document. The user also needs to re-insert manually the document back into the system.

This invention, allows for this insertion back of deleted document data into the system to be automated or semi-automated, this based partly on previous work which encompassed cloning the documentum management system, the subject of my presentation in the Documentum conference in Lisbon (Momentum May 2004). It was discovered that when creating a brand new instance of the system and copying the metadata i.e. all data contained in the primary system database, and the filestore (actual physical data) over that provided, it was consistent at a point in time when moved to the secondary system. The secondary system was a mirror of the primary system.

This concept led to this invention which captures the ‘before delete’ data and the information from the filestore in a kind of a “system recycle bin”. On request the data required, for any particular document is re-input back into the system, and in reverse order, using the recorded timestamp and document information stored in this “recycle bin”. The filestore re-populated with the files required. The user is then able once again to access the file, as was possible before it was deleted.

Some extra factors, become prevalent when returning the document back into the system, it is now important to understand how the Documentum document management system actually stores the documents within the system database. Previously, in the extraction of data as explained in an earlier submission for Patent CTC002 (title: method for preserving access to deleted and overwritten documents in April 2005), it was not necessary to understand or know the structure; simply to trap enough information to capture the necessary file name and its location. For this invention which builds upon it, however, it becomes very necessary. It also allows the reader to understand the different options which can be requested to recycle the document required back into the system.

Each document inserted into the document store is stored within an object table, even if the document is a sub type of type Engineering. For example a mug may have different features to that of a container but it still inherits the features of a container and is still a container. The system goes to the main object table retrieves the information for the document and associates the information of the particular document type to it.

Each and every document is stored in the dm_sysobject table in the system database of the documentum system as a object. It is possible therefore to have two documents with exactly the same name as completely different documents within the system; the second document with the same information that is inserted into the system as a completely new document is not necessarily a version of the first document.

This documentum system requires that a document within the filestore is actually ‘checked out’ and the changes applied and ‘checked back in’ as a new version of the document for the document to be actually a new version of the document. The most recent version of a document is known as the ‘current’ version, and has a ‘current’ flag associated with it.

An delete of a document within the document management system comprises deleting either a version of the document or each and every version of the document. An object can, however, be deleted by mistake.

An overwrite of a document consists of a user checking in by accident or by design as the same version of the document as the document that is being modified, thereby the prior document, is overwritten. Sometimes this prior work is still required, especially if the document is being worked on by two people and one person looses his work because a second person removes a clause, or, the part is slightly different in a new model of car. If the process is however, is completely reversed the new document can be lost. The user therefore has the option through this invention to return the document as a new document of the same name, or indeed to replace the document that replaced it.

### SUMMARY OF THE INVENTION

What is required is a method for allowing users to “re-cycle” (retrieve deleted and/or overwritten documents and data associated with them) documents that are still required which have been accidentally deleted and/or overwritten and are managed by a document management system.

Accordingly, there is provided a method for preserving access to deleted or overwritten document data within a system, wherein said document data is stored in a system filestore associated with a system database containing reference data to point to the document data within the system filestore, the method comprising the steps of:
determining that a delete/overwrite command has been issued;
recording the reference data prior to the deleting or updating of the reference data;
inserting the recorded reference data in a set of access-preservation tables;
inserting all other salient information connected with the before delete reference data contained within system tables into a second set of access preservation tables;
providing a set of combination tables to point to the deleted/overwritten document data within the filestore;
identifying and storing document data deleted to a separate empty filestore; and
reversing out changes using all information preserved for the required document by using sql commands on system database tables and copying the file back to the filestore, as necessary depending on user requirements; and
manipulating the data, to provide the document in the required way requested by the user.

Preferably, the reference data is contained within system tables in the system database, and wherein the method comprises using a recording step which comprises the step of recording reference data from the system tables. Preferably, the system in response to a delete/overwrite command deletes reference data from some system tables and updates reference data to other tables. Preferably, the system comprises a document management system. Preferably, the system comprises of a Documentum document management system. Preferably, the system, in response to a delete/overwrite command, deletes reference data from first and second system tables and updates reference data from a third system table. Preferably, the system comprises a Documentum document management system, and wherein the first system table comprises a dm_sysobject_s table, the second system table comprises a dm_sysobject_r table, and the third table comprises a dmr_content_r table. Preferably, the reference data comprises object identification data from the first table, version identification data from the second table, and a parent identification within the third table, wherein the parent identification can be joined to a fourth table which points to the document data in the system filestore. Preferably, the system comprises a Documentum document management system and wherein the fourth table comprises a dmr_content_s table. Preferably, the recording step comprises using a database trigger. Preferably, the recording step comprises recording the reference data using at least one Oracle trigger. Preferably, the main recording step comprises recording the reference data using a first Oracle trigger associated with the first table, a second Oracle trigger associated with the second table, and a third Oracle trigger associated with the third table. Preferably, for the first set of access-preservation tables, the set comprises a first access-preservation table to receive reference data recorded from the first system table, a second access-preservation table to receive reference data recorded from the second system table, and a third access preservation table to receive reference data recorded from the third system table, together with a date timestamp. Preferably, the method further comprises the step of using the reference data from the first set of access preservation data to obtain supplementary document information, related to the deleted/overwritten document, from system tables, together with a date timestamp. Preferably, this supplementary information includes a record of the complete reference information for each system table that holds any information pertaining to a document, before it is deleted, to be placed into a second set of access preservation tables. Preferably, the recording step used for obtaining information into the second set of access-preservation tables includes, using database triggers and SQL commands. Preferably, the recording step used for obtaining information into the second set of access-preservation tables includes, using Oracle triggers and Oracle SQL commands. Preferably, the method comprises keeping a record of the recording process with regards to recording reference data in each of the system tables concerned, and for especially in regard to each document being deleted and/or overwritten at a later stage. Preferably, the recording steps to gain the supplementary data and recording process comprise recording prior to the system executing a method that cleans the system tables to prevent access to supplementary document information for deleted/overwritten documents from the system tables. Preferably, a subset of the supplementary document information is also combined into combination tables using data recorded in the first set of access preservation tables this includes, but is not limited to information selected from the following group: a name of the document deleted or overwritten, a folder within the system database from which the document was deleted or overwritten, a storage identification of the deleted/overwritten document that indicates the position of storage within the filestore, a parent identification of the deleted/overwritten document to permit checking of the document path within the filestore, an object identification to provide filestore path information, a type of object that was deleted/overwritten, a version of the deleted/overwritten document and a date timestamp that the document was deleted/overwritten. Preferably, the method further comprises combining the first set of access-preservation tables and some supplementary document information from the system into a combined table. Preferably, the method further comprises combining the first set of access-preservation tables and a subset of the supplementary document information from the system into two combined tables one for deletes and one for overwrites. Preferably, the combining step comprises combining prior to the system executing a method that cleans the system tables to prevent access to supplementary document information for deleted/overwritten documents from the system tables. Preferably, the system comprises a Documentum document management system, and wherein the clean method is carried out by a dm_clean routine. Preferably, the method further comprises, the physical file path and file on the filestore being calculated and copied to a safe location, and prior to another documentum job to clean the filestore. Preferably, this safe location is an empty storage area with a similar path in another drive location. Preferably, this safe location is updated into the combination tables. Preferably, the method comprises that on a request for a lost document, the information can be inserted, updated back into the original database system tables, through a manual method. Preferably, the manual method comprises using the combination tables to determine relevant data required by the user. Preferably, the relevant data required is used as a input into at least one database stored procedure which references the first and second set of access preservation tables and combination table. Preferably, the relevant data required is used as a input into two database stored procedures, one for re-inserting information regarding the recycling of a deleted document, the second for inserting information regarding the recycling of an overwritten document. Preferably, the first of these procedures to carry out SQL commands to all the database system tables required, with the reference data prior to the delete of the document, depending upon user input recycling either a single version, or all versions of a document. Preferably the second of these procedures to carry out SQL commands to all the database system tables required, with the reference data prior to the overwrite of the document, depending upon user input, recycling either as a completely new document, or the ‘new’ current version of the document in the system. Preferably, the method also comprises copying the physical file back from the storage delete filestore to the main filestore. Preferably, method comprises the viewing the combination tables to select the relevant document deleted or overwritten required to be re-inserted through some control software. Preferably, the control software, takes as input, the object identified in the combination tables, the user option and uses two database stored procedures to access the information in the first, second set of access preservation tables and combination tables to restore the before delete/overwrite reference information to the relevant system tables. Preferably, the control software also issues a command which copies the file in the deleted files filestore back to the system filestore. Preferably, the control software has a user friendly interface. Preferably, the control software is written in Visual Basic. Preferably, the recording, inserting, updating and providing steps are executed by the execution of Oracle software code. Preferably, the recording, inserting, updating and providing steps are executed by the execution of SQL Server software code.

### DETAILED DESCRIPTION

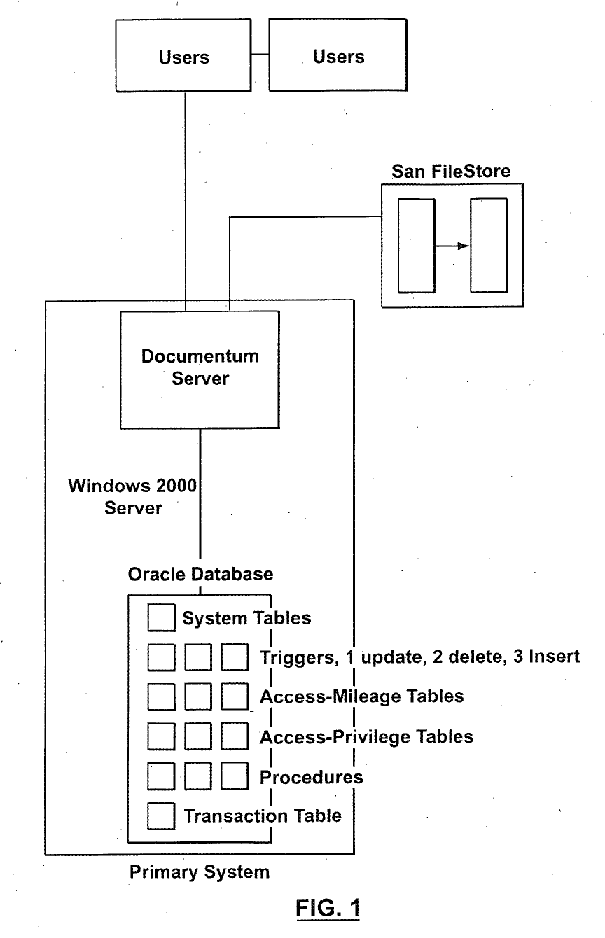

FIG. 1 shows a The preferred form of the invention which allows the capture of relevant reference data at the exact time it is deleted or updated (and any inserts) by means of Oracle database triggers supplementary data via oracle SQL commands preferably encapsulated in stored procedures shortly afterwards.

These triggers are added to the relevant Documentum tables and they automatically fire to capture the salient information needed to retrieve the pointer information to the physical data for the file by running a couple of oracle stored procedures or sql command statements, to a first set of access-preservation tables.

The second set of access preservation tables are filled with all salient information concerning the deleted object (e.g. a record of the reference data in dmr_content_s for each document/object that is deleted, the type information etc. This information is stored in an secondary access preservation table, prior to the dm_clean job. The information in the dmr_content_s table, for example is not deleted, or updated when an object is deleted, however, this is information that could be lost once dm_clean is run. Should it become necessary to restore the object data in the system tables to the state prior to the data being deleted, then the lost information in dmr_content_s needs to be present once more.

A typical Documentum system database has a number of system tables that store reference information and supplementary document information. These tables include (but are not typically limited to) the dm_sysobject_s table (first table), which stores object IDs for the documents; the dm_sysobject_r table (second table) which stores, inter alia, version IDs for documents; the dmr_content_r table (third table) which stores, inter alia, parent ID needed to find the pointer to the document within the filestore; and the dmr_content_s table (fourth table), which stores an r_object_ID that, together with the parent_ID, determines the pointer to the location of the document within the filestore.

When a document is deleted/overwritten, the relevant reference data from the first two tables is deleted, and the relevant reference data from the third table (the parent ID) is updated to a Null.

According to the invention, at least one, and preferably three, core Oracle triggers are used to catch and record the core reference data that was deleted and/or updated to the core first set of first access-preservation tables.

This reference data is then inserted into the first set of access-preservation tables (preferably one corresponding to each of the first three system tables), and the access-preservation data combined with a fourth system table to provide a combination table having the salient information to calculate the deleted/overwritten document within the filestore.

All reference data, and supplementary reference data apart from the core data above that is required to “recycle” the document on user request is inserted into a second set of access preservation tables; using database triggers, and Sql commands or stored procedures containing the sql commands. This step is performed each night and before dm_clean is run.

The document in the filestore is calculated and copied to an purpose built empty delete filestore for later retrieval and the location stored in an empty column updated in the combination table.

The method preferably further comprises the step of combining the access preservation tables and a subset of the supplementary document information into a set of at least one combined table. This step is preferably performed before the system executes a cleaning of the system tables, because at least some of the supplementary document information will not be available once a cleaning, such as a dm_clean routine, is run.

In the preferred method, the reference data from the first access preservation tables is used to obtain supplementary document information, related to the deleted/overwritten document, from the system tables to fill combination tables to help the user identify the document required to be retrieved. The core supplementary document information preferably includes, but is not limited to a name of the document deleted or overwritten, a folder within the system database from which the document was deleted or overwritten, a storage identification of the deleted/overwritten document that indicates the position of storage within the filestore, a parent identification of the deleted/overwritten document to permit checking of the document path within the filestore, an object identification to provide filestore path information, a type of object that was deleted/overwritten, a version of the deleted/overwritten document and a date that the document was deleted/overwritten.

The method preferably further comprises the step of recording and preserving all before information in the said system tables and all related system tables using oracle triggers and sql commands within database procedures with regards to each deleted/overwritten object together with a date timestamp into a secondary set of access-preservation tables. So that this information can be restored using sql commands back into the system tables where necessary in reverse-order later if needed, thereby recycling it, this even after dm_clean runs (as data has been preserved in a second set of access-preservation tables).

The method also calculates the whereabouts of the file matching the deleted document on the filestore and copies it to a safe location together with its full path, storing this location, so it can be returned if necessary to the original filestore, if the document is to be restored.

This invention captures the data and the information from the filestore in a kind of a “system recycle bin”. On request the data is re-input in reverse order to the database system tables, manipulating it where necessary depending on the user options chosen using the recorded timestamp. The filestore re-populated with the necessary file.

The transactions made on the three core tables dm_sysobject_s, dm_sysobject_r, and dmr_content_r during delete of the file by the system commands can be reversed by Sql commands encapsulated within stored procedures. Furthermore a row added to dmr_content_s if subsequently found missing. Likewise all supplementary information can be restored.

Using the base option it will appear to the user that the file was never deleted, or overwritten (In the case of an overwritten document the user must be informed that the recycling of the overwritten document will replace the version of the document that overwrote it).

In the preferred method extra options are provided which allow the user to retrieve the document as the current version, or as a, totally new document. In order not to loose the document that overwrote the one the user requires as it my also be valid. In this case the data retrieved from the set of access-preservation tables is manipulated before adding it to the system database tables to provide the necessary result.

The latest version of a document is usually the current version in Documentum.

The method preferably comprises searching and viewing the information in the combination table through a software interface which provides a Gui front-end. Upon selection of this information and retrieval option it would run database stored procedures that automatically restore the data within the database system tables and also copy over the file from the safe location back to the main filestore.

In a typical operation, the data location within the filestore at which a document is located is obtained by combining the parent ID from the third table with the r_object_ID from the fourth table to obtain the data ticket (i.e. the pointer) along with the storage ID which can be used to find the file path of the document on the filestore.

This pointer information can then be translated through commonly available Documentum support notes. The Data Ticket and the storage_id (pointer info) are two pieces of data that need to be obtained to help retrieve the document's physical file. The other information required is the r_object_id and the parent_id.

The actual path and filename are typically encrypted within the filestore to protect the document from unauthorized access. To decrypt, support note 310 is used and the parent_id taken from the combination tables described further below; before dm_clean is run, the parent ID is plugged into the Documentum APIs shown on the note through the API interface in Documentum Administrator.

For example
apply,c, 090106d450cgbs3b, GET_PATH
next,c,q0
get,c,q0,result

This gives you the path of the file on the content store (but only works before dm_clean is run).

As described below, another Documentum support note can also be used to calculate the full file path and name of the document stored on the server. This is done using the r_object_id, storage_id and Data_ticket (all values contained in the combination tables This alternate calculation of the file path and name can be compared with the above calculation using note 310 to increase the probability that the correct file path and name are known. Once dm_clean has been run, the note 310 calculation will not work, but the alternate calculation will function to find the exact place on the server or backup tape at which a deleted file resides. The method of the present invention can then be used from the time of successful comparison of the two name and path calculations. i.e. by running the procedures below automatically through either a Cron/or Veritas job.

When an object or document is deleted or overwritten, the parent_id of the document is updated and set to Null. Once this occurs there is no way to link the dmr_content_r table to the dmr_content_s table. The purpose of the recording of reference information was, inter alia, to ensure that the parent ID was recorded in order to get storage location and data ticket.

Below, there is shown sample code implementing a small portion of the invention, more columns of data are required than those shown if the document is to be recycled. A column of data in this case would represent in the case of the dm_sysobject_s the r_object_id, object_type i.e. the info contained within. The code shows the process of recording the data from the core tables.

On reversing the process the whole row of data within the dmr_content_r table it appears that the value of the parent_ID set to Null would have to be placed back, however, the whole row may be missing especially after the dm_clean method has run and have to be re-inserted entirely using an insert statement.

Code is given for both Oracle and SQL Server (For Delete is for older versions). The invention can be implemented in a multi-document management system embodiment. The invention can be implemented in a multi-database embodiment.

Oracle
create or replace trigger capture_del_s_trigger
before delete on dm_sysobject_s
for each row
Begin
kapurture_del_s(:old.r_object_id,:old.r_object_type,:old.object_name);
EXCEPTION
when others then
RAISE;
END;
/
create or replace trigger capture_i_trigger
before update on dmr_content_r
for each row
Begin
kapurture_del_i(:old.r_object_id,:old.parent_id);
EXCEPTION
When others then
RAISE;
END;
/
Create or replace trigger capture_del_r_trigger
before delete on dm_sysobject_r
for each row
Begin
kapurture_del_r(:old.r_object_id,:old.r_version_label,:old.i_folder_id);
EXCEPTION
when others then
RAISE;.
END;
/
then Sql Server:-
create trigger capture_del_r_trigger
on dbo.dm_sysobject_r
After Delete -- FOR Delete
As
if exists ( insert into capture_del_r_table values (r_object_id, r_version_label, i_folder_id)

select r_object_id, r_version_label, i_folder_id from deleted where r_object_id
in (select r_object_id from deleted)
)

go
create trigger capture_i_trigger
on dbo.dmr_content_r
After Update -- FOR Update
As
if exists ( insert into capture_i_table values (r_object_id, parent_id)

select r_object_id, parent_id from deleted where
r_object_id in (select r_object_id from deleted)
)

go
create trigger capture_del_s_trigger
on dbo.dm_sysobject_s
After Delete -- FOR Delete
As
if exists ( insert into capture_del_s_table values (r_object_id, r_object_type,
object_name,date_saved)

select r_object_id, r_object_type, object_name,getdate( ) from deleted

where

r_object_id in (select r_object_id from deleted)

)
go

In the dm_sysobject_s and dm_sysobject_r tables a “before row delete” is preferably used, meaning the data the is about to be deleted is captured. For the dmr_content_r table, a “before update row” is preferably used, meaning that the data to be updated is captured. This ensures that all salient and/or relevant information is captured.

It will be appreciated that an “after row delete” and “after row update” could also be used and are comprehended by the invention. In such a case, the old values are captured immediately upon the deletion or update.

The reference data is trapped (i.e. recorded) and inserted into three tables (again these tables would need to be extended to capture all the columns for the purposes of re-cycling):—

create table capture_i_table (
r_object_id varchar2(16),
parent_id varchar2(32),
date_saved date)
/
create table capture_del_s_table (
r_object_id varchar2(16),
r_object_type varchar2(32),
object_name varchar2(255),
date_saved date)
/
create table capture_del_r_table (
r_object_id varchar2(16),
r_version_label varchar2(32),
i_folder_id varchar2(16))
/

More tables for extra data need to be added to these tables, together with a date time stamp, in order for the method to record the salient supplementary reference data from the system tables, in regards to “recycling” or restoring the document back into the system.

The procedures, given the names R_Kapurture_del_data.plb and R_Kapurture_upd_data.plb, then are used to combine the three access-preservation tables with the dmr_content_s table to produce the combination tables and to get the all important data_ticket value which must be converted to a char using to_char(data_ticket) as well as combining other data.

Additionally, further oracle database stored procedures that reference the access-preservation tables, the combined tables are necessary to capture all the supplementary and reference information in the system tables before the method dm_clean runs into access-preservation tables.

Further procedures taking input parameters these being the object to restore and which option the user requires to restore the information captured, back to the database system tables that form the documentum document management system.

The combination tables could take the form of a single table for both deletes and overwrites. However, it is preferred that there be a combination table for deletes and one for overwrites, (again these tables contain here only a subset of the columns to necessary to ensure recycling).

create table capture_del_ro_table (
date_deleted date,
storage_id varchar2(16),
data_ticket varchar2(20),
full_format varchar2(64),
r_object_id varchar2(16),
r_object_type varchar2(32),
object_name varchar2(255),
r_version_label varchar2(32),
r_parent_id varchar2(32),
r_folder_path varchar2(255))
/
create table capture_upd_ro_table (
date_deleted date,
storage_id varchar2(16),
data_ticket varchar2(20),
full_format varchar2(64),
r_object_id varchar2(16),
r_object_type varchar2(32),
object_name varchar2(255),
r_version_label varchar2(32),
r_parent_id varchar2(32),
r_folder_path varchar2(255))
/

Once the storage_id, data_ticket, r_object_id, parent_id are available in the above tables the method of the present invention is preferably every night and just before dm_clean runs. This will ensure that all of the necessary reference data is captured.

The following is the “alternate” process referred to above for calculating the file path and name. Take the storage_id obtained and use it as the r_object_id into the table dm_store_s. This should give you the filestore concerned (there could be more than one filestore, which collectively act as the “filestore” for the document management system. The path of the filestore can be found through the Documentum administrator.

Part of the file path on the filestore is stored as a hex code. The first part of this hex code is usually contained within the r_object_id of the deleted row corresponding to the deleted document. The remainder of the filepath can be obtained by converting the data_ticket from dec to hex using the dword function on the standard scientific calculator on Microsoft windows, as the support notes will indicate.

For example if you have a data ticket say -2147561899 this converts into 75FECE55 . . . i.e the path to the file could look something like this c:\filestore1\documentum\docbase_name\00\06d450\75\FE\CE\55 where 55 is the file name on the server and 0006d450 comes from the r_object_id.

Once the formula for the file paths has been worked out by comparing with the above API method then a plsql routine could even be written to give this automatically.

Once the path is known, the name of the file, the object it relates to and the date, the document that was deleted or overwritten can be retrieved from a copy filestore if it has been cleaned off the original filestore.

Preferably, the reference data is contained within system tables in the system database, and wherein the method comprises using a recording step which comprises the step of recording reference data from the system tables. Preferably, the system in response to a delete/overwrite command deletes reference data from some system tables and updates reference data to other tables. Preferably, the system comprises a document management system. Preferably, the system comprises of a Documentum document management system. Preferably, the system, in response to a delete/overwrite command, deletes reference data from first and second system tables and updates reference data from a third system table. Preferably, the system comprises a Documentum document management system, and wherein the first system table comprises a dm_sysobject_s table, the second system table comprises a dm_sysobject_r table, and the third table comprises a dmr_content_r table. Preferably, the reference data comprises object identification data from the first table, version identification data from the second table, and a parent identification within the third table, wherein the parent identification can be joined to a fourth table which points to the document data in the system filestore. Preferably, the system comprises a Documentum document management system and wherein the fourth table comprises a dmr_content_s table. Preferably, the recording step comprises using a database trigger. Preferably, the recording step comprises recording the reference data using at least one Oracle trigger. Preferably, the main recording step comprises recording the reference data using a first Oracle trigger associated with the first table, a second Oracle trigger associated with the second table, and a third Oracle trigger associated with the third table. Preferably, for the first set of access-preservation tables, the set comprises a first access-preservation table to receive reference data recorded from the first system table, a second access-preservation table to receive reference data recorded from the second system table, and a third access preservation table to receive reference data recorded from the third system table, together with a date timestamp. Preferably, the method further comprises the step of using the reference data from the first set of access preservation data to obtain supplementary document information, related to the deleted/overwritten document, from system tables, together with a date timestamp. Preferably, this supplementary information includes a record of the complete reference information for each system table that holds any information pertaining to a document, before it is deleted, to be placed into a second set of access preservation tables. Preferably, the recording step used for obtaining information into the second set of access-preservation tables includes, using database triggers and SQL commands. Preferably, the recording step used for obtaining information into the second set of access-preservation tables includes, using Oracle triggers and Oracle SQL commands. Preferably, the method comprises keeping a record of the recording process with regards to recording reference data in each of the system tables concerned, and for especially in regard to each document being deleted and/or overwritten at a later stage. Preferably, the recording steps to gain the supplementary data and recording process comprise recording prior to the system executing a method that cleans the system tables to prevent access to supplementary document information for deleted/overwritten documents from the system tables. Preferably, a subset of the supplementary document information is also combined into combination tables using data recorded in the first set of access preservation tables this includes, but is not limited to information selected from the following group: a name of the document deleted or overwritten, a folder within the system database from which the document was deleted or overwritten, a storage identification of the deleted/overwritten document that indicates the position of storage within the filestore, a parent identification of the deleted/overwritten document to permit checking of the document path within the filestore, an object identification to provide filestore path information, a type of object that was deleted/overwritten, a version of the deleted/overwritten document and a date timestamp that the document was deleted/overwritten. Preferably, the method further comprises combining the first set of access-preservation tables and some supplementary document information from the system into a combined table. Preferably, the method further comprises combining the first set of access-preservation tables and a subset of the supplementary document information from the system into two combined tables one for deletes and one for overwrites. Preferably, the combining step comprises combining prior to the system executing a method that cleans the system tables to prevent access to supplementary document information for deleted/overwritten documents from the system tables. Preferably, the system comprises a Documentum document management system, and wherein the clean method is carried out by a dm_clean routine. Preferably, the method further comprises, the physical file path and file on the filestore being calculated and copied to a safe location, and prior to another documentum job to clean the filestore. Preferably, this safe location is an empty storage area with a similar path in another drive location. Preferably, this safe location is updated into the combination tables. Preferably, the method comprises that on a request for a lost document, the information can be inserted, updated back into the original database system tables, through a manual method. Preferably, the manual method comprises using the combination tables to determine relevant data required by the user. Preferably, the relevant data required is used as a input into at least one database stored procedure which references the first and second set of access preservation tables and combination table. Preferably, the relevant data required is used as a input into two database stored procedures, one for re-inserting information regarding the recycling of a deleted document, the second for inserting information regarding the recycling of an overwritten document. Preferably, the first of these procedures to carry out SQL commands to all the database system tables required, with the reference data prior to the delete of the document, depending upon user input recycling either a single version, or all versions of a document. Preferably the second of these procedures to carry out SQL commands to all the database system tables required, with the reference data prior to the overwrite of the document, depending upon user input, recycling either as a completely new document, or the ‘new’ current version of the document in the system. Preferably, the method also comprises copying the physical file back from the storage delete filestore to the main filestore. Preferably, method comprises the viewing the combination tables to select the relevant document deleted or overwritten required to be re-inserted through some control software. Preferably, the control software, takes as input, the object identified in the combination tables, the user option and uses two database stored procedures to access the information in the first, second set of access preservation tables and combination tables to restore the before delete/overwrite reference information to the relevant system tables. Preferably, the control software also issues a command which copies the file in the deleted files filestore back to the system filestore. Preferably, the control software has a user friendly interface. Preferably, the control software is written in Visual Basic. Preferably, the recording, inserting, updating and providing steps are executed by the execution of Oracle software code. Preferably, the recording, inserting, updating and providing steps are executed by the execution of SQL Server software code.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. A method for preserving access to deleted and overwritten data within a system containing reference data to point to data within the system filestore the method comprising steps of:
(a) determining that a delete/overwrite command has been issued;
(b) recording and physically separating the reference data prior to the deleting and updating of the reference data;
(c) access preserving said reference data recorded;
(d) access preserving supplementary reference data associated with the before delete or overwritten reference data contained within the system;
(e) providing a combination means to combine said reference data and the supplementary data associated to point to the deleted/overwritten data within the system filestore with a date timestamp;
(f) identifying and storing data deleted or overwritten from within the system filestore separately to a storage filestore;
(g) identifying and storing the safe location of said deleted or overwritten data to said combination means;
(h) a means to allow storage of said combinations means to the storage filestore;
(i) accessing the combination means to identify and retrieve the reference data and the supplementary data associated using a gui;
(j) accessing the combination means to identify and retrieve the data deleted or overwritten back to the system filestore, from the storage filestore.
(k) retrieving and manipulating the reference data as necessary to retrieve the deleted or overwritten data as the original file or a new version of the data.

59. A method as claimed in claim 58 wherein the reference data is contained within the system and wherein the recording step comprises the step of recording reference data from the system along with a date-timestamp and recording the data deleted or overwritten from the system filestore to the storage filestore.

60. A method as claimed in claim 59 wherein the reference data associated with the before deleted or overwritten data including the supplementary reference data in response to a delete or overwrite command is recorded and preserved in a means to access preserve, and combined before at least one clean up routine(s) is run.

61. A method as claimed in claim 59 wherein the data on a delete/overwrite command is traced on the filestore and is moved to the storage filestore.

62. A method as claimed in claim 60 wherein on searching the reference data in the means to access preserve, combine and selecting the required data for retrieval the reference data is copied back to the system, using the preserved information.

63. A method as claimed in claim 61 wherein the method comprises copying back the required data from the storage filestore in response to a retrieval command, to its original system filestore location.

64. A system for preserving access to deleted and overwritten data within a system containing reference data to point to data within the system filestore comprising steps of:
(l) a means to determine that a delete/overwrite command has been issued;
(m) a means to record and physically separate recorded reference data, deleted from that overwritten prior to deleting, overwriting of the reference data;
(n) a means to access preserve the reference data recorded;
(o) a means to access preserve supplementary reference data associated with the before delete or overwritten reference data contained within the system;
(p) a combination means operable to combine the reference data and the supplementary data associated to point to the deleted/overwritten data within the system filestore with a date-timestamp;
(q) a means to identify, store and separate, the data deleted/overwritten within documents with exactly the same name to the storage filestore;
(r) a means to store and identify the safe location of said deleted or overwritten data in the storage filestore to said combination means;
(s) means to identify and retrieve the reference data, the supplementary data associated and the data deleted or overwritten from the storage filestore wherein the data is viewed on a graphical user interface (gui);
(t) a means to allow store of said combination means to the storage filestore.

65. A system as claimed in claim 64 wherein the reference data is contained within the system and wherein the means to record comprises the step of recording separated deleted/overwritten reference data to the system along with a date-timestamp.

66. A system as claimed in claim 64 wherein the reference data is contained within the system and wherein the means to record comprises the step of recording deleted/overwritten data from the system filestore to the storage filestore separately as new data of the same name along with the date-timestamp.

67. A system as claimed in claim 66 wherein the reference data associated with the before deleted or overwritten data including the supplementary reference data in response to the delete or the overwrite command is recorded and preserved in the means to access preserve, and combined in said combination means before at least one clean up routine(s) is run.

68. A system as claimed in claim 64, wherein the method in response to a retrieval command by individual(s), allows search, view of deleted and overwritten data from the storage filestore allowing return of the original data or as a version of the data along with the date-timestamp.

69. A system as claimed in claim 64 wherein the reference data comprises object, parent and version identification.

70. A system for preserving deleted or overwritten document data within a document management system, wherein said document data is stored in a system filestore associated with a system database containing reference data to point to the document data within the system filestore, comprising:
(u) a data base for storing data and reference data pointing to said document data within said system;
(v) means for determining that a delete/overwrite command has been issued;
(w) at least one trigger for catching and recording reference data prior to the deleting or updating of the reference data;
(x) a first set of access-preservation tables tar storing said recorded reference data deleted or overwritten reference data;
(y) a second set of access-preservation tables for supplementary document information associated with the before delete or overwritten reference data
(z) means to combine the recorded reference data stored in the first set of access-preservation tables and supplementary document information in the second set of access-preservation tables;
(aa) a storage filestore for storing document data deleted or overwritten;
(bb) means for copying the deleted or overwritten document data from the storage filestore to the system filestore.

71. A system as claimed in claim 70, wherein said database comprises at least three system tables for recording reference data.

72. A system as claimed in claim 71 comprising a stored procedure for deleting reference data from the first and second system tables and updates reference data from the third system table.

73. A system as claimed in claim 70 including a combined table comprising the access-preservation table and the supplementary document information.

74. A computer containing a system for preserving access to deleted and overwritten data within a system containing reference data to point to data within the system filestore as recited in claim 64.

75. A USB containing a system for preserving access to deleted and overwritten data within a system containing reference data to point to data within the system filestore recited in claim 64.

76. A system for preserving access to deleted and overwritten data within a system containing reference data to point to data within the system filestore for connection to a Document/Object Management System as recited in claim 64.

77. A Object/Document Management System containing a system for preserving access to deleted and overwritten data within a system containing reference data to point to data within the system filestore as recited in claim 64.
